(19) United States
(12) Patent Application Publication
(10) Pub. No.: US 2018/0071954 A1
(43) Pub. Date: Mar. 15, 2018

(54) Mixing Tool

(71) Applicant: Samuel L Roye, Capitola, CA (US)

(72) Inventor: Samuel L Roye, Capitola, CA (US)

(21) Appl. No.: 15/703,350

(22) Filed: Sep. 13, 2017

Related U.S. Application Data
(60) Provisional application No. 62/393,838, filed on Sep. 13, 2016.

(51) Int. Cl. B28C 5/44; B28C 7/12; B28C 7/14; B01F 7/00; B01F 13/00; B01F 15/00

(52) U.S. Cl. CPC B28C 5/44; B28C 7/128; B28C 7/14; B01F 2003/1257; B01F 7/007; B01F 13/002; B01F 15/00506; B01F 7/00291

(57) ABSTRACT

A mixing tool has an elongated tubular conduit with a flattened portion at a lower end, a garden hose fitting joined to an upper end, a mixing blade having one or more horizontal wings, a tapered lower end, and an extension at an upper end inserted into the flattened portion and fastened through walls of the flattened portion, and two opposing, horizontal hand grips joined to the elongated tubular conduit at a position closer to the garden hose fitting than to the mixing blade. A user is enabled to prepare a pourable concrete mix by inserting the mixing blade into a quantity of dry ingredients, connecting a garden hose, causing water to flow through the elongated tubular conduit, around the mixing blade extension, into the dry ingredients, and turning the mixing blade by manipulating the opposing horizontal handgrips, to mix the moistened dry ingredients into the pourable concrete mix.

### CROSS-REFERENCE TO RELATED DOCUMENTS

The present patent application is a non-provisional application claiming priority to provisional application 62/393,838, filed on Sep. 13, 2016 entitled “Mixing Tool”. Disclosure of prior application is incorporated herein in its entirety by reference.

### BACKGROUND OF THE INVENTION

### 1. Field of the Invention

The present invention is in the technical area of tools for mixing concrete and ingredients, and pertains more particularly to setting fence posts.

### 2. Description of Related Art

Setting fence posts is a well-known process wherein, in at least one circumstance, a round hole is drilled into the earth for a prescribed depth, such as twenty-four inches, a (usually) treated wooden post is placed in the hole, dry concrete post mix is poured into the hole around the post, water is added, and some means of mixing the water into the dry material is utilized. In many cases the mixing may be accomplished by rodding with a steel bar, such as rebar.

Mixing in this fashion is more often than not inefficient and incomplete, and the quality and strength of the concrete mix when set may be poor. What is clearly needed is a tool and a process whereby the concrete mix may be quickly and thoroughly mixed with the right amount of water, so it sets properly with maximum strength,

### BRIEF SUMMARY OF THE INVENTION

In one embodiment of the invention, a mixing tool is provided, comprising an elongated tubular conduit having a length and a diameter, and a flattened portion at a lower end, to a width greater than the diameter, and to a first dimension between inside walls of the flattened portion, a male thread garden hose fitting joined to an upper end, opposite the lower end of the elongated tubular conduit, a mixing blade having a thickness less than the dimension between the inside walls of the flattened portion, one or more horizontal wings, a tapered lower end, and an extension at an upper end, of a width less than the width of the flatted portion of the elongated tubular conduit, the extension at the upper end inserted into the flattened portion of the elongated tubular conduit and fastened therein by one or more fasteners through walls of the flattened portion and through the extension of the mixing blade, and two opposing, horizontal hand grips joined to the elongated tubular conduit at a position closer to the garden hose fitting than to the mixing blade. A user is enabled to prepare a pourable concrete mix by inserting the mixing blade into a quantity of dry ingredients for concrete held in a container, connecting a garden hose to the garden hose fitting at the upper end, causing water to flow at a constrained rate through the elongated tubular conduit, around the mixing blade extension, into the dry ingredients, and turning the mixing blade by manipulating the opposing horizontal handgrips, to mix the moistened dry ingredients into the pourable concrete mix.

In one embodiment of the invention, the tool further comprises a manually-operable water valve joined to the garden hose fitting, enabling the user to control water flow while mixing. Also in one embodiment the manually-operated water valve is a blade-operated valve. In one embodiment the tool further comprises rubber or polymer covers on the opposing handgrips. And in one embodiment the elongated tubular conduit comprises two sections, one of which fits into the other with a locking mechanism, enabling the user to adjust the overall length of the mixing tool.

### BRIEF DESCRIPTION OF THE SEVERAL VIEWS OF THE DRAWINGS

FIG. 1 is an elevation view of a mixing tool in an embodiment of the present invention.

FIGS. 2A and 2B are a plan and a side view respectively of the mixing blade in FIG. 1.

FIG. 3 is an end view of a lowermost end of a main tube of the tool of FIG. 1.

FIG. 4 illustrates the mixing tool with a spring-loaded valve imposed between a hose and the tool.

FIG. 5 illustrates a slip joint that may be used in some embodiments of the invention at an intermediate position in the height of the tool.

### DETAILED DESCRIPTION OF THE INVENTION

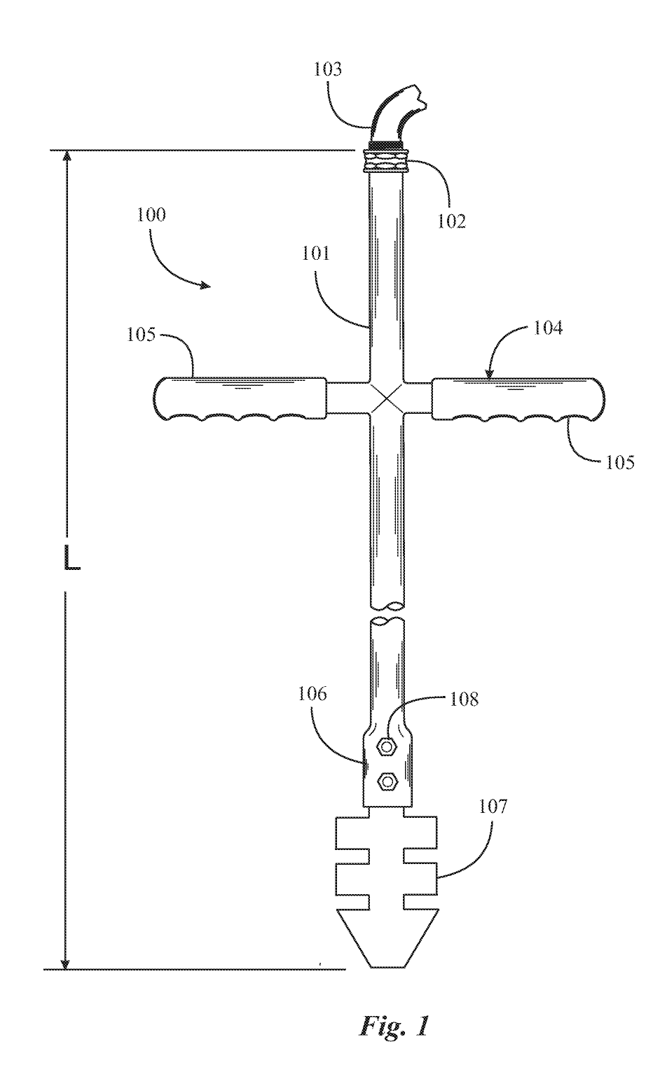

FIG. 1 is an elevation view of a mixing tool 100 in an embodiment of the present invention. Mixing tool 100 is based on a vertical tube 101, which may be standard metal pipe, such as steel or copper pipe or tubing. A standard hose fitting 102 is provided on a topmost end of tube 101 to connect to a garden hose 103 in this embodiment, supplying water to an otherwise dry concrete mix in a post hole. In some embodiments a valve, not shown in FIG. 1, but described in more detail below, is included to control water flow into tube 101.

A pair of opposing handgrips 104 is added at a convenient height on tubing 101, providing control and leverage for a user to push and turn a mixing blade 107 that is fastened by standard fasteners 108 to tube 101 at a lowermost end of the tool. Rubber-like grips 105 in this example are provided for convenience over the handgrips, for user comfort, but are not a limitation in the invention.

Tube 101 is flattened at the lowermost end in region 106 to accept an extension of mixing blade 107. Sufficient passage is provided around the extension of mixing blade 107 for restricted water flow from tube 101 out and around blade 107, as is described in more detail below.

Mixing tool 100 is shown foreshortened in FIG. 1, so details may be seen larger, and will have an overall length L which will be sufficient to extend the mixing end of the tool to the bottom of a post hole, and to position in that circumstance the hand grips 104 at a convenient height for a user to manipulate the tool.

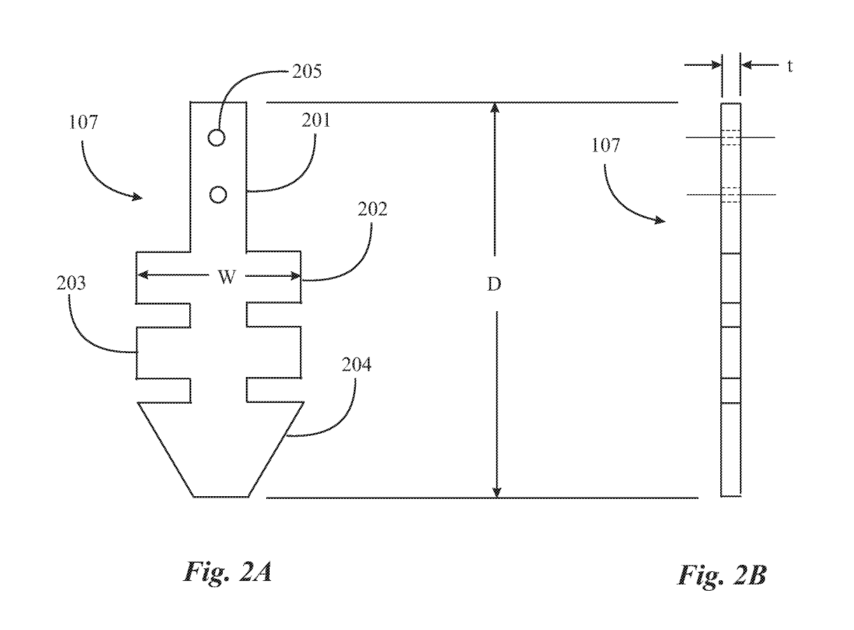

FIGS. 2A and 2B are a plan and a side view respectively of mixing blade 107 of FIG. 1. The blade has an extension 201 to insert into an opening in the lowermost end of the tube of the mixing toll, and, in this example, two mounting holes 205 through which fasteners may extend through both the flattened lowermost end of tube 101 and the blade 107, to hold the blade in the tube. Exposed portions of blade 107 include horizontal wings 202 and 203, spaced apart vertically, and a lowermost region 204 tapered in aspect, which aids in insertion of the blade into material to be mixed.

Blade 107 in one embodiment has an overall height D of about five inches, but this height may vary in different embodiments. The overall width in this embodiment is about two inches, but this may vary as well. The thickness tin this embodiment is about one-quarter inch, but this may vary as well.

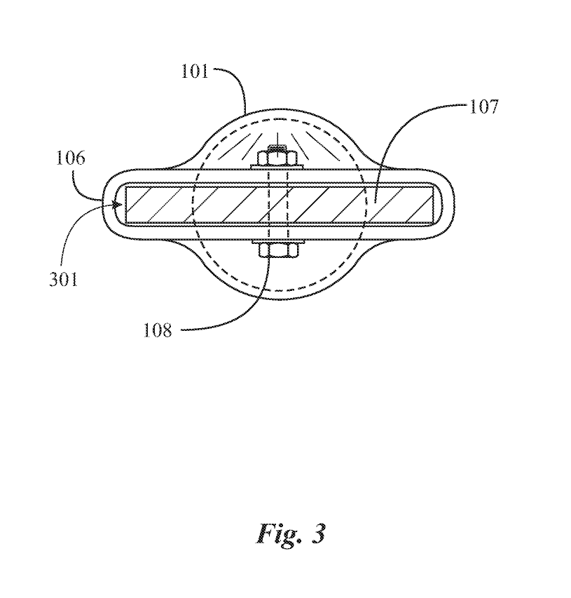

FIG. 3 is an end view of lowermost end 106 of main tube 101 of the tool of FIG. 1. As may be seen in this figure, in this embodiment tube 101 is flattened for some length at the lowermost end, providing an oblong shape that is sufficiently wide that the opening 301 produced is of a height and width sufficient to accept extension 201 of blade 107, which is fastened in place by two conventional fasteners, in this case hex bolts with hex nuts, that pass through holes in region 106 o tube 101 and through holes 205 of blade 107, so blade 107 is held firmly in place, as shown in FIG. 1.

It is to be noted that, with blade 107 fastened in region 106 of tube 101, there is space between extension 201 of blade 101 and the inside surface of region 106, allowing water under pressure that enters tube 101 from hose 103 to pass out of the tube around the blade. This passage of water is necessary in the process of mixing the material in a post hole.

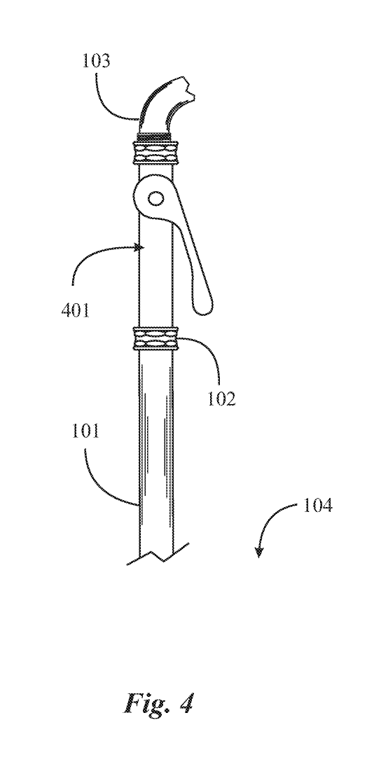

FIG. 4 illustrates the uppermost end of tube 101 of tool 100 with a spring-loaded valve 401 imposed between hose 103 and tube 101. An important purpose of valve 401 in many embodiments of the invention is to enable a user of the tool, in mixing the dry ingredients in a post hole, to add water to the mix during the mixing process, which the user may do in incremental, small amounts by depressing the valve handle repeatedly for short periods of time.

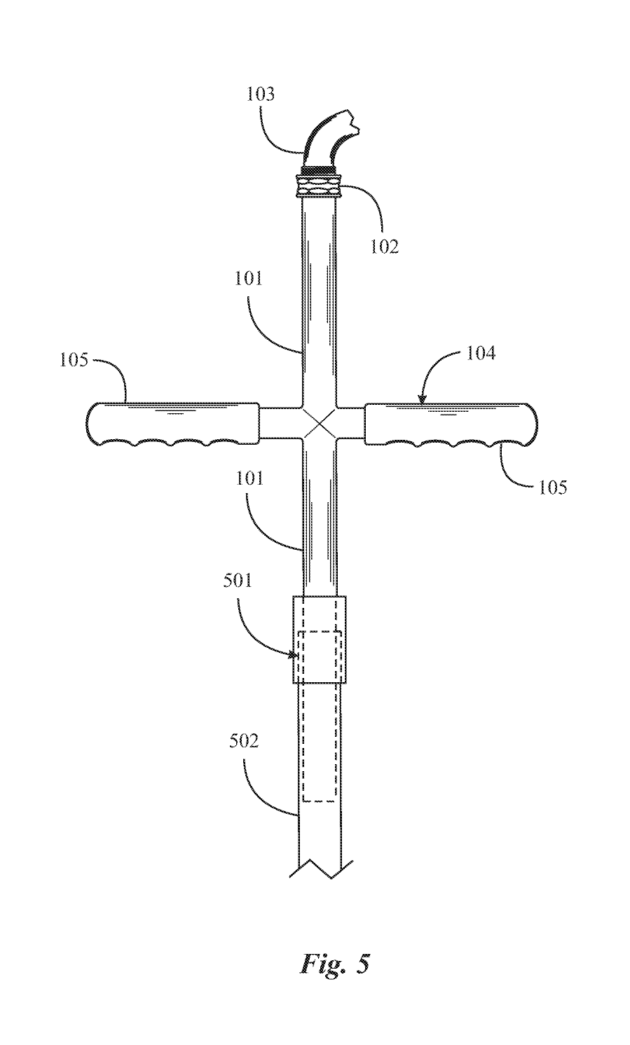

FIG. 5 illustrates a slip joint 501 that may be used in some embodiments of the invention at an intermediate position in the height of the tool. Tube 101 in this embodiment telescopes into a tube 502 that has an inside diameter just large enough to accept the outside diameter of tube 101. Joint 501 enables a user to loosen the joint, slide the tubes relative to one another, and tighten the joint again, to adjust the overall length of the tool, which may be advantageous, given that not all post holes may be the same depth, and not all users may be of the same height. Such adjustment enables a user to control the length L of the tool, so the tool will reach the bottom of a post hole while the opposing handgrips are presented at a convenient height for the user of the tool.

In a typical operation a user may drill a plurality of post holes, each of a common depth, perhaps twenty-four inches, for example, then place treated posts in each post hole. After placement of the posts, the user pours a measured quantity of dry post concrete mixture into each of the holes. This mixture typically consists of sand, fly ash, cement and gravel. There are a variety of mixes that may be used, and that are commercially available. The user than inserts tool 100 into the post hole beside the post, grasps the opposing handgrips, and turns to tool back and forth to mix the material while injecting water into the mixture. The tool may be moved and used at different positions around the post to be sure all of the material gets thoroughly mixed.

In some cases, the user may adjust the length of the tool, assuming the depth of the post holes. After mixing the user may adjust the position of the post in the post hole to be vertical.

The skilled person will understand that the descriptions herein are not limiting, and that there are variations not specifically described that may fall within the scope of the invention. For example, there are alternative materials for the tubing used in the tool, and for the hose to supply water. Various sorts of valves may be used. The mixing blade may take other shapes than that specifically shown and described. In some cases, the tube of the tool may be joined in sections, allowing addition or removal of sections to adjust the length of the tool. The mixing blade is preferably a hardened steel blade, and may be hardened by any one of several methods, and may be composed of several different alloys of metal.

1. A mixing tool, comprising:
an elongated tubular conduit having a length and a diameter, and a flattened portion at a lower end, to a width greater than the diameter, and to a first dimension between inside walls of the flattened portion;
a male thread garden hose fitting joined to an upper end, opposite the lower end of the elongated tubular conduit;
a mixing blade having a thickness less than the dimension between the inside walls of the flattened portion, one or more horizontal wings, a tapered lower end, and an extension at an upper end, of a width less than the width of the flatted portion of the elongated tubular conduit, the extension at the upper end inserted into the flattened portion of the elongated tubular conduit and fastened therein by one or more fasteners through walls of the flattened portion and through the extension of the mixing blade; and
two opposing, horizontal hand grips joined to the elongated tubular conduit at a position closer to the garden hose fitting than to the mixing blade;
wherein a user is enabled to prepare a pourable concrete mix by inserting the mixing blade into a quantity of dry ingredients for concrete held in a container, connecting a garden hose to the garden hose fitting at the upper end, causing water to flow at a constrained rate through the elongated tubular conduit, around the mixing blade extension, into the dry ingredients, and turning the mixing blade by manipulating the opposing horizontal handgrips, to mix the moistened dry ingredients into the pourable concrete mix.

2. The mixing tool of claim 1 further comprising a manually-operable water valve joined to the garden hose fitting, enabling the user to control water flow while mixing.

3. The mixing tool of claim 2 wherein the manually-operated water valve is a blade-operated valve.

4. The mixing tool of claim 1 further comprising rubber or polymer covers on the opposing handgrips.

5. The mixing tool of claim 1 wherein the elongated tubular conduit comprises two sections, one of which fits into the other with a locking mechanism, enabling the user to adjust the overall length of the mixing tool.
